(19) United States
(12) Patent Application Publication
(10) Pub. No.: US 2022/0364537 A1
(43) Pub. Date: Nov. 17, 2022

(54) IGNITION COIL CONTROL SYSTEM

(71) Applicants: Hyundai Motor Company, Seoul (KR); Kia Corporation, Seoul (KR)

(72) Inventors: Kiseon SIM, Whasung-Si (KR); Dongwon JUNG, Whasung-Si (KR); Won Gyu KIM, Whasung-Si (KR); Jin Oh SONG, Whasung-Si (KR); Soo Hyung WOO, Whasung-Si (KR)

(73) Assignees: Hyundai Motor Company, Seoul (KR); Kia Corporation, Seoul (KR)

(21) Appl. No.: 17/530,202

(22) Filed: Nov. 18, 2021

(30) Foreign Application Priority Data
May 11, 2021 (KR) 10-2021-0060440

(51) Int. Cl. F02P 3/05; F02P 3/045; F02P 15/00

(52) U.S. Cl. CPC F02P 3/051; F02P 3/0453; F02P 15/006

(57) ABSTRACT

An ignition coil control system may include first and second ignition coils, and a spark plug including a pair of electrodes in which generates spark discharge by discharge currents of the first ignition coil and the second ignition coil, a DC-DC converter connected to a primary coil of the first ignition coil, a primary coil of the second ignition coil and a battery; in which converts current magnitude supplied to a primary coil of the first ignition coil and a primary coil of the second ignition coil from a battery, and a controller in which controls the spark discharge of the electrodes by adjusting an amount and a duration of the discharge current of the first ignition coil and the second ignition coil base on a pulse signal, wherein the controller is configured to selectively execute a multi-state ignition through the first ignition coil and the second ignition coil and a single-stage ignition through one of the first ignition coil and the second ignition coil according to an operation region of an engine.

### CROSS-REFERENCE TO RELATED APPLICATION

The present application claims priority to Korean Patent Application No. 10-2021-0060440 filed on May 11, 2021, the entire contents of which is incorporated herein for all purposes by this reference.

### BACKGROUND OF THE INVENTION

### Field of the Invention

The present invention relates to an ignition coil control system, and more particularly, to an ignition coil control system that adjusts current applied to a primary coil of an ignition coil according to an operating region of an engine.

### Description of the Related Art

In gasoline vehicles, a mixture of air and fuel is ignited by a spark generated by a spark plug to be combusted. That is, the air-fuel mixture injected into a combustion chamber during a compression stroke is ignited by a discharge phenomenon of the spark plug, and thus energy required for vehicle's driving is generated while undergoing a high temperature and high pressure expansion process.

The spark plug provided in the gasoline vehicle serves to ignite a compressed air-fuel mixture by spark discharge caused by a high voltage current generated by an ignition coil.

In a spark plug mounted on a conventional engine, as high voltage current (or discharge current) is generated in a secondary coil of the ignition coil due to an electromagnetic induction with current applied to a primary coil, spark discharge occurs between a center electrode and a ground electrode.

However, an arc resistance in a combustion chamber varies according to an operation region of an engine, which causes a problem in that the discharge current generated in the secondary coil varies.

For example, in a high-speed and high-load region of the operation region, the flow around the spark plug in the combustion chamber becomes stronger, and therefore, the arc resistance around the spark plug is increased. Accordingly, the discharge energy generated in the secondary coil is relatively reduced.

Meanwhile, in a low-speed and low-load region of the operation region, the flow around the spark plug in the combustion chamber becomes weaker, and therefore, the arc resistance around the spark plug is decreased. Accordingly, the discharge energy generated in the secondary coil is relatively increased.

In summary, there was a problem that the discharge energy by the spark plug varied according to flow state in the combustion chamber.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing an ignition coil control system which may adjust discharge energy of a spark plug according to an operation region of an engine.

An ignition coil control system according to various exemplary embodiments of the present invention may include a first ignition coil; a second ignition coil; a spark plug including a pair of electrodes in which generates spark discharge by discharge currents of the first ignition coil and the second ignition coil; a DC-DC converter connected to a primary coil of the first ignition coil, a primary coil of the second ignition coil and a battery, wherein the DC-DC converter is configured to convert current magnitude supplied to the primary coil of the first ignition coil and the primary coil of the second ignition coil from the battery; and a controller connected to the DC-DC converter and configured for controlling the spark discharge of the electrodes by adjusting an amount and a duration of the discharge current of the first ignition coil and the second ignition coil according to a pulse signal of the controller; wherein the controller is configured to selectively execute a multi-state ignition through the first ignition coil and the second ignition coil and a single-stage ignition through one of the first ignition coil and the second ignition coil according to an operation region of an engine.

The controller may execute the multi-state ignition in a first region, in which an exhaust gas recirculation (EGR) gas is used in the engine or a lean combustion is performed, and executes the single-stage ignition in a second region excluding the first region.

The controller may increase the current magnitude supplied to the primary coil of the first ignition coil and the primary coil of the second ignition coil through the DC-DC converter as an engine speed and an engine load are increased in the first region.

An ignition coil control system according to various exemplary embodiments of the present invention may include a first ignition coil including a primary coil and a secondary coil; a first switch that selectively electrically connects the primary coil of the first ignition coil; a second ignition coil including a primary coil and a secondary coil; a second switch that selectively electrically connects the primary coil of the second ignition coil; a spark plug including a center electrode and a ground electrode in which generates spark discharge by discharge currents generated in the first ignition coil and the second ignition coil, or discharge current generated in one of the first ignition coil and the second ignition coil; and a controller in which controls the spark discharge generated between the center electrode and the ground electrode by adjusting an amount and a duration of the discharge currents of the first ignition coil and the second ignition coil by turning the first switch and the second switch on or off according to a pulse signal of the controller, and selectively executes a multi-state ignition through the first ignition coil and the second ignition coil and a single-stage ignition through one of the first ignition coil and the second ignition coil according to an operation region of an engine.

The operation region of the engine may include a first region that an EGR gas is used in the engine or a lean combustion is performed, and a second region excluding the first region.

The controller may execute the multi-stage ignition in the first region, and executes the single-stage ignition in the second region.

The controller may increase a current magnitude supplied to the primary coil of the first ignition coil and the primary coil of the second ignition coil through the DC-DC converter as an engine speed and an engine load are increased in the first region.

According to various exemplary embodiments of the present invention, since the multi-stage ignition or the single-state ignition is selectively executed according to the operation region of the engine, it is possible to improve ignition property of the mixture gas and prevent unnecessary power consumption.

Furthermore, by increasing current magnitude supplied to the primary coil as the engine speed and the engine load increase in the operation region using lean combustion or EGR gas, it is possible to prevent the ignition energy from being decreased by fast flow and pressure inside the cylinder in the high-speed and high-load region.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates a schematic view of an engine system according to various exemplary embodiments of the present invention.

FIG. 2 illustrates a cross-sectional view of an engine in which a spark plug is mounted according to various exemplary embodiments of the present invention.

FIG. 3 illustrates a schematic view of an ignition coil control system according to various exemplary embodiments of the present invention.

FIG. 4, FIG. 5, FIG. 6 and FIG. 7 illustrate flowcharts of an ignition coil control method according to various exemplary embodiments of the present invention.

FIG. 8 illustrates an operation of an ignition coil in a first region according to various exemplary embodiments of the present invention.

FIG. 9 illustrates graph of operation regions according to various exemplary embodiments of the present invention.

FIG. 10 illustrates graph of a relationship between an ignition energy and a current supplied to a primary coil in a first region according to various exemplary embodiments of the present invention.

FIG. 11 illustrates graph a relationship between an ignition energy and a current supplied to a primary coil in a first region according to a related art.

FIG. 12 illustrates operation of an ignition coil in a second region according to various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments, but further various alternatives, modifications, equivalents and other embodiments, which may be included within the spirit and scope of the present invention as defined by the appended claims.

Exemplary embodiments of the present application will be described more fully hereinafter with reference to the accompanying drawings, in which exemplary embodiments of the present invention are shown. As those skilled in the art would realize, the described embodiments may be modified in various different ways, all without departing from the spirit or scope of the present invention.

To clearly describe the present invention, parts that are irrelevant to the description are omitted, and identical or similar constituent elements throughout the specification are denoted by the same reference numerals.

Furthermore, since the size and thickness of each configuration shown in the drawings are arbitrarily shown for convenience of description, the present invention is not necessarily limited to configurations illustrated in the drawings, and to clearly illustrate several parts and areas, enlarged thicknesses are shown.

First, an engine system applied with an ignition coil control system according to various exemplary embodiments of the present invention will be described in detail with reference to an accompanying drawing.

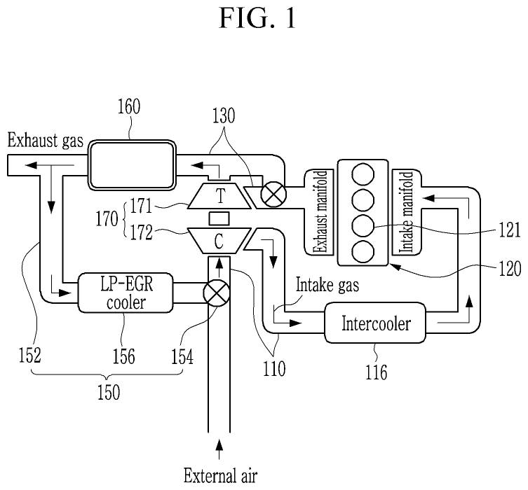

FIG. 1 illustrates a schematic view of an engine system according to various exemplary embodiments of the present invention.

As shown in FIG. 1, an engine system according to various exemplary embodiments of the present invention includes an engine 120 including a plurality of cylinders 121 generating driving torque by combusting fuel, an intake line 110 through which intake gas to be supplied to the cylinders 121 flows, an exhaust line 130 through which exhaust gas discharged from the cylinders 121 flows, a turbocharger 170 compressing the intake gas supplied to the cylinders 121 and recirculated exhaust gas (hereinafter, will be referred to as “recirculation gas”), and an EGR apparatus (exhaust gas recirculation apparatus) 150 that recirculates exhaust gas discharged from the cylinder to the cylinder.

A catalytic converter 160, which removes various types of deleterious substances included in exhaust gas discharged from the cylinder 121, is provided in the exhaust line 130. To remove nitrogen oxide (NOx), the catalytic converter 160 may include a lean NOx trap (LNT), a diesel oxidation catalyst, and a diesel particulate filter.

The turbocharger 170 includes a turbine 171 which is provided in the exhaust line 130 and rotates by exhaust gas discharged from the cylinder 121, and a compressor 72 which rotates in conjunction with the rotation of the turbine 171 and compresses intake gas and recirculation gas.

The EGR apparatus 150 includes an EGR line 152 branched off from the exhaust line 130 and merged into the intake line 110, an exhaust gas recirculation (EGR) cooler 156 provided in the EGR line 152, and an EGR valve 154 provided in the EGR line 152. The EGR cooler 156 cools exhaust gas having high temperature recirculated through the EGR line 152. An amount of exhaust gas recirculated through the EGR line 152 is adjusted by an opening of the EGR valve 154.

An intercooler 116 is provided in the intake line 110 downstream portion of the compressor 172, and cools mixed gas (external air and recirculation gas) having high temperature and high pressure compressed by the compressor 172.

A spark plug is mounted in the cylinders 121 of the engine.

Hereinafter, a spark plug according to various exemplary embodiments of the present invention will be described in detail with reference to an accompanying drawing.

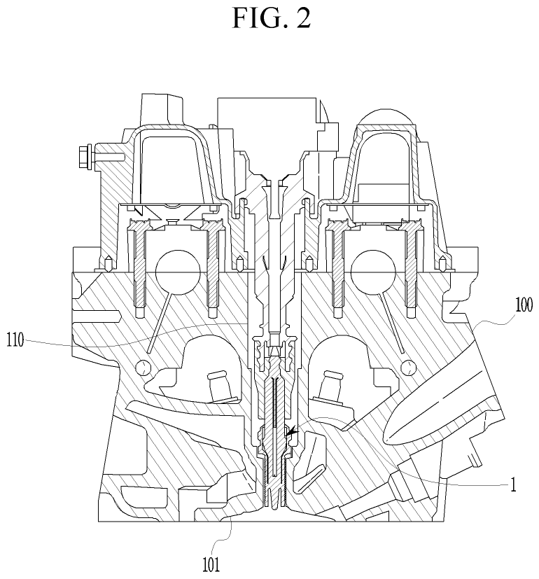

FIG. 2 illustrates a cross-sectional view of an engine in which a spark plug is mounted according to various exemplary embodiments of the present invention.

As shown in FIG. 2, a spark plug 1 according to various exemplary embodiments of the present invention is mounted on a cylinder of an engine, and generates spark discharge.

The engine to which the spark plug 1 is applied includes a cylinder block and a cylinder head 100, and the cylinder block and the cylinder head 100 are combined to form a combustion chamber 101 therein. An air and fuel mixture inflowing into the combustion chamber 101 is ignited by spark discharge generated by the spark plug 1.

In the cylinder head 100, a mount hole 110 in which the spark plug 1 is mounted is vertically formed long. A lower portion of the spark plug 1 which is mounted in the mount hole 110 protrudes into the combustion chamber 101. A center electrode 2 and a ground electrode 3 that are electrically connected to an ignition coil are formed at the lower portion of the spark plug 1, and the spark discharge is generated between the center electrode 2 and the ground electrode 3.

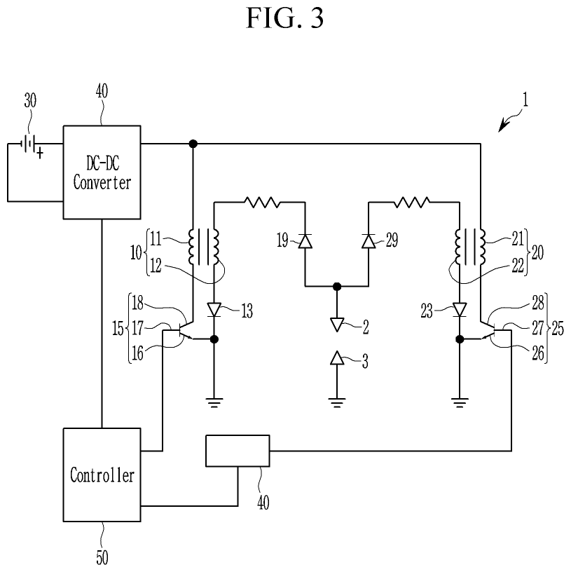

FIG. 3 illustrates a schematic view of an ignition coil control system according to various exemplary embodiments of the present invention.

As shown in FIG. 3, an ignition coil control system according to various exemplary embodiments of the present invention may include a controller 50 controlling overall operation of an engine, a first ignition coil 10, and a second ignition coil 20.

The controller 50 may control spark discharge generated between a pair of electrodes by adjusting amounts and durations of discharge currents of two ignition coils (a first ignition coil 10 and a second ignition coil 20) based on a first pulse signal having constant voltage and a second pulse signal following the first pulse signal for a delay time. In various exemplary embodiments of the present invention, the controller 50 may be distributed in plural or integrated.

The first ignition coil 10 includes a primary coil 11 and a secondary coil 12, one end portion of the primary coil 11 is electrically connected to a battery 30 of a vehicle, and the other end portion of the primary coil 11 is grounded through a first switch 15. According to an on/off operation of the first switch 15, the primary coil 11 of the first ignition coil 10 may be selectively electrically connected.

The first switch 15 may be realized with a Negative-Positive-Negative (NPN) type transistor switch including an emitter terminal 16, a collector terminal 18, and a base terminal 17. That is, the other end portion of the primary coil 11 may be electrically connected to the collector terminal 18 of the first switch 15, the emitter terminal 16 thereof may be grounded, and the base terminal 17 thereof may be electrically connected to the ignition controller 40.

One end portion of the secondary coil 12 is electrically connected to the center electrode 2, and the other end portion thereof is electrically connected to the emitter terminal 16 of the first switch 15. A diode 13 is provided between the secondary coil 12 and the emitter terminal 16 to block a current from flowing from the secondary coil 12 to the emitter terminal 16.

Furthermore, a diode 19 is provided between the secondary coil 12 and the center electrode 2, so that current flows only from the secondary coil 12 to the center electrode 2.

When a control signal is applied to the base terminal 17 of the first switch 15 by the controller 50, the primary coil 11 of the first ignition coil 10 is electrically connected, and electrical energy is charged to the primary coil 11. When no control signal is applied to the base terminal 17 of the first switch 15 by the controller 50, a high voltage current (or discharge current) is generated in the secondary coil 12 due to electromagnetic induction of the primary coil 11 and the secondary coil 12. The discharge current generated in the secondary coil 12 flows to the center electrode 2, and while spark discharge being generated between the center electrode 2 and the ground electrode 3 by the discharge current generated in the secondary coil 12, an air-fuel mixture inside the combustion chamber 101 is ignited.

That is, the controller 50 charges or discharges the first ignition coil 10 by turning on/off the first switch 15. When the controller 50 applies a control signal to the base terminal 17 of the first switch 15 (or when the switch is turned on), the primary side coil 11 is charged (or the first ignition coil is charged).

Furthermore, when the controller 50 does not apply a control signal to the base terminal 17 of the first switch 15 (or when the first switch is turned off), a high voltage current is generated in the secondary coil 12 due to electromagnetic induction with the primary coil 11, and spark discharge is generated between the center electrode 2 and the ground electrode 3 (or the first ignition coil is discharged) by the high voltage current generated in the secondary coil 12.

Like the first ignition coil 10, the second ignition coil 20 includes a primary coil 21 and a secondary coil 22, one end portion of the primary coil 21 is electrically connected to the battery 30 of the vehicle, and the other end portion of the primary coil 21 is grounded through a second switch 25. According to an on/off operation of the second switch 25, the primary coil 21 of the second ignition coil 20 may be selectively electrically connected.

The second switch 25 may be realized with a Negative-Positive-Negative (NPN) type transistor switch including an emitter terminal 26, a collector terminal 28, and a base terminal 27. That is, the other end portion of the primary coil 21 may be electrically connected to the collector terminal 28 of the second switch 25, the emitter terminal 26 thereof may be grounded, and the base terminal 27 thereof may be electrically connected to the controller 50.

One end portion of the secondary coil 22 is electrically connected to the center electrode 2, and the other end portion thereof is electrically connected to the emitter terminal 26 of the second switch 25. A diode 23 is provided between the secondary coil 22 and the emitter terminal 26 to block a current from flowing from the secondary coil 22 to the emitter terminal 26.

Furthermore, the diode 23 is provided between the secondary coil 22 and the center electrode 2, so that a current flows only from the secondary coil 22 to the center electrode 2.

When a control signal is applied to the base terminal 27 of the second switch 25 by the controller 50, the primary coil 21 of the second ignition coil 20 is electrically connected, and electrical energy is charged to the primary coil 21. When no control signal is applied to the base terminal 27 of the second switch 25 by the controller 50, a high voltage current (or discharge current) is generated in the secondary coil 22 due to electromagnetic induction of the primary coil 21 and the secondary coil 22. The discharge current generated in the secondary coil 22 flows to the center electrode 2, and while spark discharge being generated between the center electrode 2 and the ground electrode 3 by the discharge current generated in the secondary coil 22, an air-fuel mixture inside the combustion chamber 101 is ignited.

That is, the ignition controller 40 charges or discharges the second ignition coil 20 by turning the second switch 25 on/off. When the controller 50 applies a control signal to the base terminal 27 of the second switch 25 (or when the switch is turned on), the primary side coil 21 is charged (or the second ignition coil is charged).

Furthermore, when the controller 50 does not apply a control signal to the base terminal 27 of the second switch 25 (or when the second switch is turned off), a high voltage current is generated in the secondary coil 22 due to electromagnetic induction with the primary coil 21, and spark discharge is generated between the center electrode 2 and the ground electrode 3 (or the second ignition coil is discharged) by the high voltage current generated in the secondary coil 22.

In the specification of the present invention, charging the primary coil of the first ignition coil 10 by turning on the first switch 15 is referred to as charging the first ignition coil 10, and a high voltage current is induced to the secondary coil of the first ignition coil 10 by turning off the first switch 15 and thus spark discharge occurs between the center electrode 2 and the ground electrode 3 is referred to as the first ignition coil 10 being discharged.

Likewise, charging the primary coil of the second ignition coil 20 by turning on the second switch 25 is referred to as charging the second ignition coil 20, and a high voltage current is induced to the secondary coil of the second ignition coil 20 by turning off the second switch 25 and thus spark discharge occurs between the center electrode 2 and the ground electrode 3 is referred to as the second ignition coil 20 being discharged.

Meanwhile, a DC-DC converter 40 is disposed between the battery 30 and the primary coil 11 of the first ignition coil 10, and between the battery 30 and the primary coil 21 of the second ignition coil 20.

The current output from the battery 30 is raised or reduced through the DC-DC converter, and supplied to the primary coil 11 of the first ignition coil 10 and the primary coil 21 of the second ignition coil 20. The DC-DC converter 40 is operated by a control signal of the controller 50.

The ignition coil control system according to various exemplary embodiments of the present invention may selectively execute a multi-stage ignition that generates spark discharges in the spark plug through the two ignition coils, and a single-stage ignition that generates spark discharges in the spark plug through any one ignition coil of the two ignition coils (first ignition coil and second ignition coil) based on operating region of the engine.

For this, the controller 50 may be provided as at least one processor executed by a predetermined program, and the predetermined program is configured to perform respective steps of an ignition coil control method according to various exemplary embodiments of the present invention.

Hereinafter, the operation of the ignition coil control system according to the exemplary embodiment of the present invention as described above will be described in detail with reference to the accompanying drawings.

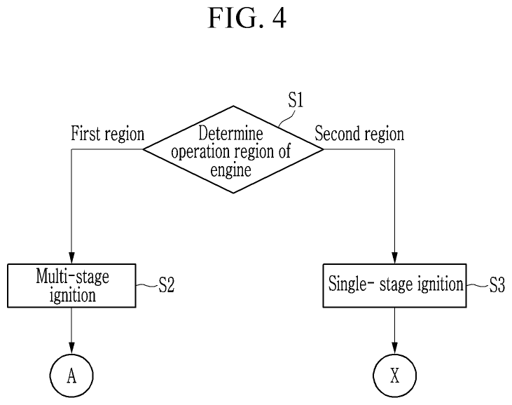

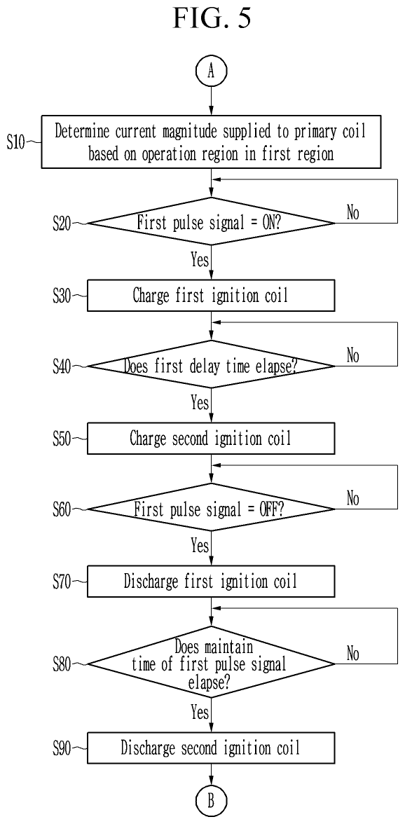

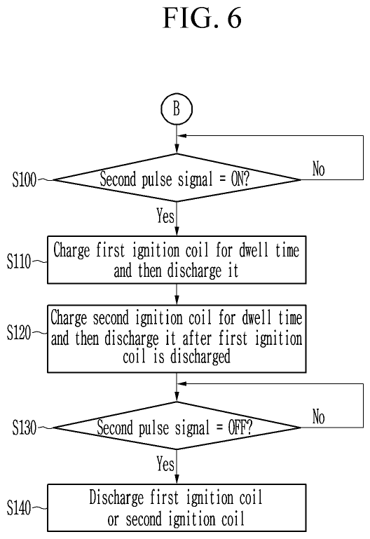

FIG. 3, FIG. 4, FIG. 5, FIG. 6, and FIG. 7 illustrate flowcharts of an ignition coil control method according to various exemplary embodiments of the present invention.

As shown in FIG. 3, FIG. 4, FIG. 5, FIG. 6, and FIG. 7, the controller is configured to determine controller is configured to determine operating region of the engine (S1), and selectively executes the multi-stage ignition and the single-stage ignition (S2 and S3).

The multi-stage ignition may mean generating spark discharge between the center electrode 2 and the ground electrode 3 of the spark plug 1 by use of the two ignition coils (first ignition coil and second ignition coil), and the single-stage ignition may mean generating spark discharge between the center electrode 2 and the ground electrode 3 of the spark plug 1 by use of any one of the two ignition coils (first ignition coil and second ignition coil).

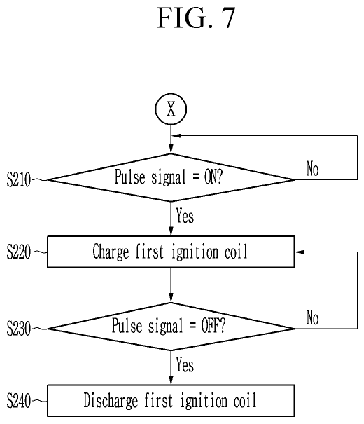

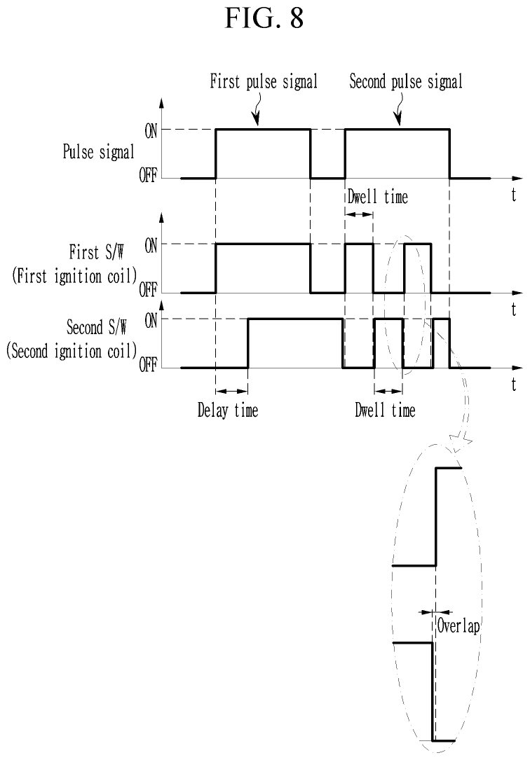

Referring to FIG. 8, the operating region of the engine may be divided into a first region and a second region in various exemplary embodiments of the present invention.

The first region may mean an operating region that supplies the recirculation gas (EGR gas) to the cylinder of the engine by use of the EGR apparatus, or performs a combustion that is leaner than a theoretical air-fuel ratio. In other words, the first region may be an operating region using the EGR gas, or an operating region performing a lean combustion.

In the first region, since the EGR gas inflows into the cylinder, or the lean combustion is performed, by executing the multi-stage ignition, sufficient ignition energy may be supplied to the mixture gas (air and fuel) in the cylinder, thereby improving ignition property of the mixture gas.

The second region may be the remained operating region except for the first region. Since the ignition property if the mixture gas is not a problem in the second region, unnecessary power consumption may be prevented by performing the single-stage ignition.

Referring back to FIG. 3, FIG. 4, FIG. 5, FIG. 6, and FIG. 7, when the operating region of the engine is the first region (S1), the controller is configured to execute the multi-stage ignition that charges and discharges the two ignition coils by use of two pulse signals (S2).

Referring to FIG. 8, two pulse signals includes a first pulse signal and a second pulse signal following the first pulse signal for a predetermined delay time, and the first and the second pulse signal having constant voltage (e.g., 12V) and predetermined period, respectively. The second pulse signal may have the same voltage (e.g., 12V) as the first pulse signal.

Here, the period of the first pulse signal (or, maintaining time of the first pulse signal) may be determined as a time during which the first ignition coil 10 and the second ignition coil 20 are fully charged.

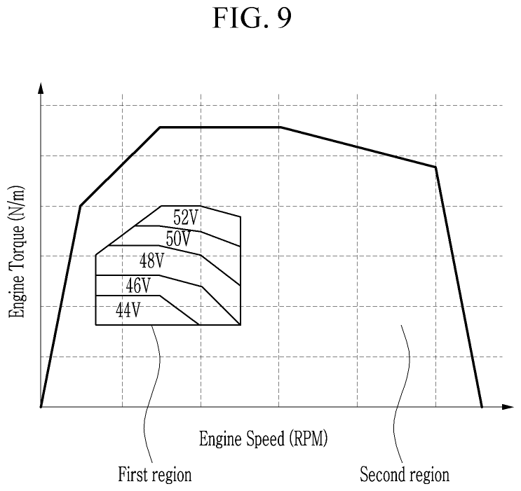

Referring to FIG. 9, the controller is configured to divide the first region into plural operating regions (e.g., 5 operating regions) according to engine speed and engine load, determines the operating region in the first region, and determines current magnitude supplied to the primary coil 11 of the first ignition coil 10 and the primary coil 21 of the second ignition coil 20 based on the operating region in the first region (S10).

In the instant case, as the engine speed and the engine load are increased, the controller gradually increases current magnitude supplied to the primary coil 11 of the first ignition coil 10 and the primary coil 21 of the second ignition coil 20 from the battery through the DC-DC converter 40.

That is, when the engine speed and the engine load are small, the controller decreases current magnitude supplied to the primary coil 11 of the first ignition coil 10 and the primary coil 21 of the second ignition coil 20 from the battery through the DC-DC converter 40.

When the engine speed and the engine load are increased in the first region, the controller is configured to increase a current magnitude supplied to the primary coil 11 of the first ignition coil 10 and the primary coil 21 of the second ignition coil 20 from the battery through the DC-DC converter 40.

At the present time, as the engine speed and the engine load are increased, the controller is configured to increase a current magnitude supplied to the primary coil 11 of the first ignition coil 10 and the primary coil 21 of the second ignition coil 20 through the DC-DC converter 40 step by step.

For example, the first region may be divided into a 1-1 region to 1-5 region according to the engine speed and the engine load. Here, the engine speed and the engine load are increased as the 1-1 region going from the 1-1 region to the 1-5 region.

The controller may supply DC current of 44V to the primary coil 11 of the first ignition coil 10 and the primary coil 21 of the second ignition coil 20 through the DC-DC converter 40 in the 1-1 region. The controller may supply DC current of 46V to the primary coil 11 of the first ignition coil 10 and the primary coil 21 of the second ignition coil 20 through the DC-DC converter 40 in the 1-2 region. The controller may supply DC current of 48V to the primary coil 11 of the first ignition coil 10 and the primary coil 21 of the second ignition coil 20 through the DC-DC converter 40 in the 1-3 region. The controller may supply DC current of 50V to the primary coil 11 of the first ignition coil 10 and the primary coil 21 of the second ignition coil 20 through the DC-DC converter 40 in the 1-4 region. Furthermore, the controller may supply DC current of 52V to the primary coil 11 of the first ignition coil 10 and the primary coil 21 of the second ignition coil 20 through the DC-DC converter 40 in the 1-5 region.

Since pressure and flow around the center electrode 2 and the ground electrode 3 of the spark plug 1 are relatively small when the engine speed and the engine load are low in the first region, the discharge energy of the center electrode 2 and the ground electrode 3 is relatively slowly decreased. Accordingly, if current applied to the primary coil 11 of the first ignition coil 10 and the primary coil 21 of the second ignition coil 20 is relatively decreased (e.g., 44V) when the engine speed and the engine load is low in the first region (e.g., 1-1 region), the magnitude of current induced in the secondary coil 12 of the first ignition coil 10 and the secondary coil 22 of the second ignition coil 20 is relatively reduced, and the discharge energy of the center electrode 2 and the ground electrode 3 of the spark plug 1 is relatively decreased. The discharge energy of the spark 1 may be determined based on the current induced in the secondary coils of the ignition coil.

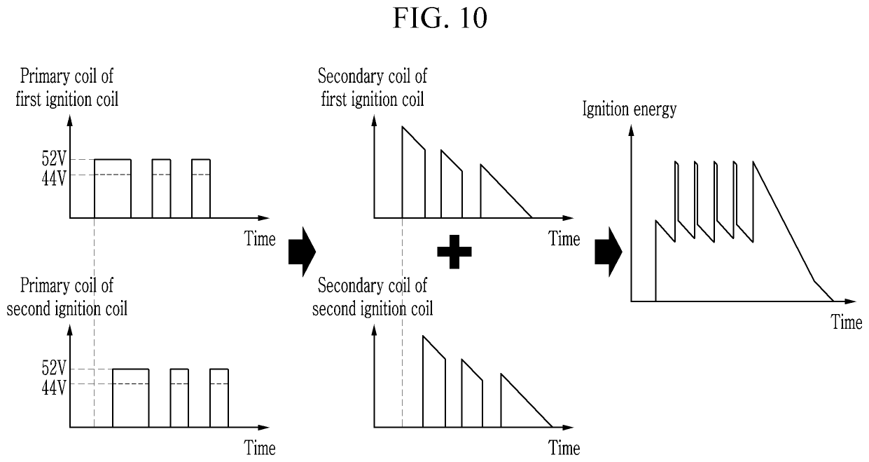

Since pressure and flow around the center electrode 2 and the ground electrode 3 of the spark plug 1 are relatively strong when the engine speed and the engine load are high in the first region, the discharge energy of the center electrode 2 and the ground electrode 3 is relatively rapidly decreased. Accordingly, if current applied to the primary coil 11 of the first ignition coil 10 and the primary coil 21 of the second ignition coil 20 is relatively increased (e.g., 52V) when the engine speed and the engine load is low in the first region (e.g., 1-5 region), the magnitude of current induced in the secondary coil 12 of the first ignition coil 10 and the secondary coil 22 of the second ignition coil 20 is relatively increased, and the discharge energy of the center electrode 2 and the ground electrode 3 of the spark plug 1 is relatively increased (refer to dotted line of FIG. 10). Through this, even if the pressure and flow around the center electrode 2 and the ground electrode 2 are strong, sufficient ignition property of a mixture gas may be obtained.

As described above, by adjusting the magnitude of current applied to the primary coil of the ignition coil, the magnitude of current induced in the secondary coil and the discharge energy generated at the center electrode 2 and the ground electrode 2 may be kept constant.

Even if pressure and flow around the center electrode 2 and the ground electrode 3 according to the engine speed and the engine load, by adjusting the magnitude of current supplied to the primary coil of the ignition coil, the discharge energy generated between the center electrode 2 and the ground electrode 3 of the spark plug 1 may be kept constant, thereby obtaining sufficient ignition property of the mixture gas in the high-speed and high-load region.

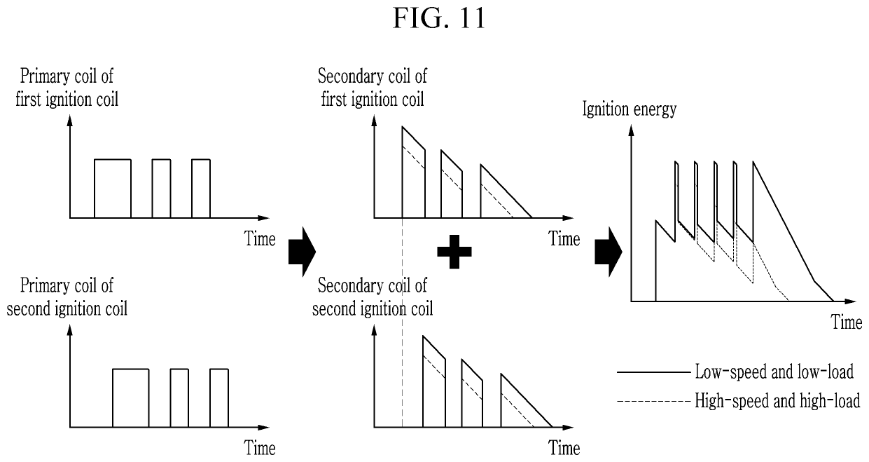

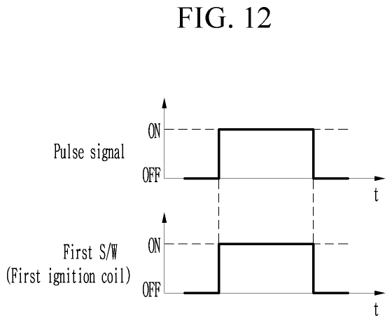

If the magnitude of current supplied to the primary coil of the ignition coil is not changed according to the operating region of the engine, the magnitude of current induce in the secondary coil is changed by pressure and flow in the cylinder as shown in FIG. 11, which causes a problem in that the discharge energy varies depending on the operating region.

As shown in FIG. 11, in the low-speed and low-load region of the first region, current magnitude induced in the secondary coil is relatively increased, thus the ignition energy is relatively increased (refer to solid line of FIG. 11).

On the other hand, in the high-speed and high-load region of the first region, current magnitude induced in the secondary coil is relatively decreased, thus the ignition energy is relatively decreased (refer to dotted line of FIG. 11).

Therefore, the magnitude of the ignition energy is different according to the operation in the first region.

The ignition controller charges the first ignition coil 10 and then discharges the first ignition coil 10 in synchronization with the first pulse signal. That is, the ignition controller 50 turns on the first switch 15 to charge the first ignition coil 10 10 in synchronization with ON time of the first pulse signal (or, when the first pulse signal is on) at step S30.

When a first delay time elapses from the time point at which the first pulse signal is on at step S40, the ignition controller 50 turns on the second switch 25 to charge the second ignition coil 20 at step S50.

The ignition controller 50 turns off the first switch 15 to discharge the first ignition coil 10 in synchronization with OFF time of the first pulse signal. That is, when the first pulse signal is off at step S60, the ignition controller 50 turns off the first switch 15 to discharge the first ignition coil 10 at step S70.

When the maintaining time of the first pulse signal elapses from the charging time point of the second ignition coil 20 at step S80, the ignition controller 50 discharges the second ignition coil 20 by turning off the second switch 25 at step S90.

The ignition controller 50 charges and then discharges the first ignition coil 10 in synchronization with the second pulse signal. That is, when the first pulse signal is on at step S100, the ignition controller 50 turns on the first switch 15 to charge the first ignition coil 10 during a dwell time and then discharge the first ignition coil 10 at step S110. Here, the dwell time may be shorter than the maintaining time of the first pulse signal, and shorter than the maintaining time of the second pulse signal.

After the first ignition coil 10 is discharged, the ignition controller 50 charges the second ignition coil 20 during the dwell time and then discharged the second ignition coil 20 at step S120.

When the second pulse signal is not turned off at S130, steps S110 and S112 are repeated. That is, the ignition controller 50 repeats charging and discharging of the first ignition coil 10 and the second ignition coil 20 until the second pulse signal is off.

In the instant case, after the first ignition coil 10 is initially discharged, the ignition controller 50 adjusts the charging timing and discharging timing of the first ignition coil 10, and the charging timing and discharging timing of the second ignition coil 20, so that a charging period of the first ignition coil 10 and a charging period of the second ignition coil 20 do not overlap. In other words, after the first ignition coil 10 is initially discharged, the discharging period of the first ignition coil 10 and the discharging period of the second ignition coil 20 may overlap.

As described above, when the discharging period of the first ignition coil 10 and the discharging period of the second ignition coil 20 overlap, the spark discharge is continuously generated between the center electrode 2 and the ground electrode 3, and ignition energy may be efficiently transmitted to the air-fuel mixture in the combustion chamber 101. Therefore, the discharge efficiency of the spark plug 1 may be improved.

When the second pulse signal is off at step S120, the ignition controller 50 discharges the first ignition coil 10 or the second ignition coil 20 at step S140. For example, when the second pulse signal is off while the first ignition coil 10 is being charged, the ignition controller 50 discharges the first ignition coil 10 when the second pulse signal is off. Furthermore, when the second pulse signal is off while the second ignition coil 20 is being charged, the ignition controller 50 discharges the second ignition coil 20 when the second pulse signal is off.

When the operation region of the engine is the second region at step S1, the ignition controller is configured to execute the single-stage ignition that charges and discharges one (e.g., first ignition coil) of the two ignition coils by use of one pulse signal at step S3.

The pulse signal has constant voltage (e.g., 12V) and a predetermined period. The period of the pulse signal may be determined as a time during which the ignition coil is fully charged.

The controller 50 charges the first ignition coil 10 and then discharges the first ignition coil 10 in synchronization with the pulse signal. That is, the controller 50 turns on the first switch 15 to charge the first ignition coil 10 at step S220 when the pulse signal is on at step S230.

Accordingly, the controller 50 turns off the first switch 15 to discharge the first ignition coil 10 at step S240 when the pulse signal is off at step S230.

As described above, according to various exemplary embodiments of the present invention, since the multi-stage ignition or the single-state ignition is selectively executed according to the operation region of the engine, it is possible to improve ignition property of the mixture gas and prevent unnecessary power consumption.

Furthermore, by increasing current magnitude supplied to the primary coil as the engine speed and the engine load increase in the operation region using lean combustion or EGR gas, it is possible to prevent the ignition energy from being decreased by fast flow and pressure inside the cylinder in the high-speed and high-load region.

Furthermore, the term related to a control device such as “controller”, “control unit”, “control device” or “control module”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present invention. The control device according to exemplary embodiments of the present invention may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method included in the aforementioned various exemplary embodiments of the present invention.

The aforementioned invention can further be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include hard disk drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present invention, each operation described above may be performed by a control device, and the control device may be configured by multiple control devices, or an integrated single control device.

In various exemplary embodiments of the present invention, the control device may be implemented in a form of hardware or software, or may be implemented in a combination of hardware and software.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

Furthermore, the term of “fixedly connected” signifies that fixedly connected members always rotate at a same speed. Furthermore, the term of “selectively connectable” signifies “selectively connectable members rotate separately when the selectively connectable members are not engaged to each other, rotate at a same speed when the selectively connectable members are engaged to each other, and are stationary when at least one of the selectively connectable members is a stationary member and remaining selectively connectable members are engaged to the stationary member”.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

1. An ignition coil control system, comprising:
a first ignition coil;
a second ignition coil;
a spark plug including a pair of electrodes which generate spark discharge by discharge currents of the first ignition coil and the second ignition coil;
a DC-DC converter connected to a primary coil of the first ignition coil, a primary coil of the second ignition coil and a battery, wherein the DC-DC converter is configured to convert a current magnitude supplied to the primary coil of the first ignition coil and the primary coil of the second ignition coil from the battery; and
a controller connected to the DC-DC converter and configured for controlling the spark discharge of the electrodes by adjusting an amount and a duration of the discharge currents of the first ignition coil and the second ignition coil according to a pulse signal of the controller;
wherein the controller is configured to selectively execute a multi-stage ignition through the first ignition coil and the second ignition coil and a single-stage ignition through one of the first ignition coil and the second ignition coil according to an operation region of an engine,
wherein the operation region of the engine includes a first region,
wherein the controller is configured to execute the multi-stage ignition in the first region, in which an exhaust gas recirculation (EGR) gas is used in the engine or a lean combustion is performed,
wherein the operation region of the engine further includes a second region,
wherein the controller is configured to execute the single-stage ignition in the second region excluding the first region,
wherein the controller is configured to increase the current magnitude supplied to the primary coil of the first ignition coil and the primary coil of the second ignition coil through the DC-DC converter as an engine speed and an engine load are increased in the first region, and
wherein the controller is configured to increase the current magnitude supplied to the primary coil of the first ignition coil and the primary coil of the second ignition coil through the DC-DC converter by increasing a voltage applied to the primary coil of the first ignition coil and the primary coil of the second ignition coil step by step as the engine speed and the engine load are increased in the first region.

2-5. (canceled)

6. The ignition coil control system of claim 1, wherein one of the electrodes is connected to a secondary coil of the first ignition coil and a secondary coil of the second ignition coil and another of the electrodes is grounded.

7. An ignition coil control system, comprising:
a first ignition coil including a primary coil and a secondary coil;
a first switch that selectively electrically connects the primary coil of the first ignition coil;
a second ignition coil including a primary coil and a secondary coil;
a second switch that selectively electrically connects the primary coil of the second ignition coil;
a spark plug including a center electrode and a ground electrode which generate spark discharge by discharge currents generated in the first ignition coil and the second ignition coil, or discharge current generated in one of the first ignition coil and the second ignition coil; and
a controller connected to the first switch and the second switch,
wherein the controller is configured to control the spark discharge generated between the center electrode and the ground electrode by adjusting an amount and a duration of the discharge currents of the first ignition coil and the second ignition coil by turning the first switch and the second switch on or off according to a pulse signal of the controller, and
wherein the controller is configured to selectively execute a multi-stage ignition through the first ignition coil and the second ignition coil and a single-stage ignition through the one of the first ignition coil and the second ignition coil according to an operation region of an engine,
wherein the operation region of the engine includes:
a first region, in which an exhaust gas recirculation (EGR) gas is used in the engine or a lean combustion is performed; and
a second region excluding the first region,
wherein the controller is configured to execute the multi-stage ignition in the first region, and configured to execute the single-stage ignition in the second region,
wherein the ignition coil control system further includes a DC-DC converter connected to the primary coil of the first ignition coil, the primary coil of the second ignition coil and a battery,
wherein the controller is configured to increase a current magnitude supplied to the primary coil of the first ignition coil and the primary coil of the second ignition coil through the DC-DC converter as an engine speed and an engine load are increased in the first region, and
wherein the controller is configured to increase the current magnitude supplied to the primary coil of the first ignition coil and the primary coil of the second ignition coil through the DC-DC converter by increasing a voltage applied to the primary coil of the first ignition coil and the primary coil of the second ignition coil step by step as the engine speed and the engine load are increased in the first region.

8-11. (canceled)

12. The ignition coil control system of claim 7, wherein the center electrode is connected to the secondary coil of the first ignition coil and the secondary coil of the second ignition coil and the ground electrode is grounded.

13. The ignition coil control system of claim 7, further including:
an ignition controller connected to the controller and the second switch and configured for charging or discharging the second ignition coil by selectively turning the second switch on.

14. The ignition coil control system of claim 13,
wherein the first switch is a Negative-Positive-Negative (NPN) transistor switch including a first emitter terminal, a first collector terminal, and a first base terminal, and the primary coil of the first ignition coil is connected to the first collector terminal of the first switch, the first emitter terminal is connected to the secondary coil of the first ignition coil and grounded, and the first base terminal is connected to the controller, and
wherein the second switch is a Negative-Positive-Negative (NPN) transistor switch including a second emitter terminal, a second collector terminal, and a second base terminal, and the primary coil of the second ignition coil is connected to the second collector terminal of the second switch, the second emitter terminal is connected to the secondary coil of the second ignition coil and grounded, and the second base terminal is connected to the ignition controller.
